(19) United States
(12) Patent Application Publication
(10) Pub. No.: US 2009/0172645 A1
(43) Pub. Date: Jul. 2, 2009

(54) CALL STACK EVALUATION TO ASSURE PROPER FRAMEWORK ACCESS

(75) Inventors: Christian BEHRENS, Wiesloch (DE); Steffen ROTSCH, Rauenberg (DE); Martin SCHOLZ, Nussloch (DE)

Correspondence Address: KENYON & KENYON LLP, ONE BROADWAY, NEW YORK, NY, 10004, US

(73) Assignee: SAP AG, Walldorf (DE)

(21) Appl. No.: 11/965,388

(22) Filed: Dec. 27, 2007

(51) Int. Cl. G06F 9/44

(52) U.S. Cl. 717/128

(57) ABSTRACT

A computer program product, system and method for verifying a call stack is provided and includes framework modules accessing an image of a call stack, verifying the call stack is compatible with a called framework module, and performing a default operation if the call stack is not compatible with a called framework module.

### FIELD OF THE INVENTION

The present invention relates generally to the field of software development using a software framework. More particularly, the present invention relates to giving a framework module access to the call stack of the operating system in order to ensure proper functioning of the framework module.

### BACKGROUND

Software developers frequently look to reuse portions of old computer code when developing new software applications. Reusing software speeds up development of new programs and leads to unified solutions that have similar behavior and exhibit similar problems, thus making the processes of debugging and updating easier. Prior to writing new applications, software developers may research and identify existing software that might have reusable portions. When writing new applications without the use of old software, a developer may do so with the intent of developing central services or frameworks that can be used for later products.

Software developers use frameworks to aid in software development by eliminating a need for redeveloping portions of code for features that appear in multiple applications. For example, a developer might design customized databases for its customers. Although every database will be unique depending on a particular customer's desires, certain features, such as saving data, printing screens, navigating from one screen to another, and so on, will be apparent in all or most of the databases. Rather than recoding this functionality every time the developer creates a new database, it would be more efficient to develop a framework for handling these features. Any given new database program may be a combination of application modules and framework modules, with the application modules being unique to each particular database program and the framework modules being common between multiple database programs.

When a framework module or other type of coding is reused, the reused portions of the code need to be correctly accessed, meaning they must be accessed in the way they were intended to be accessed or else they might not function properly. For example, a framework module may have dependencies such as a single module must have been executed before, a sequence of modules must have been executed before, different sequences of modules must have been executed before, a certain module must not have been executed before, or a certain module must not have been executed in a certain order before. Embodiments of the present invention provide an improved system and method for determining if these dependencies have been met, thus improving the efficiency and ease associated with using a software framework to develop new computer programs.

### BRIEF DESCRIPTION OF THE DRAWINGS

FIG. 1 is a block diagram showing an example computer network in accordance with an embodiment of the present invention.

FIG. 2 is a block diagram showing an example structure of a workstation which may be a part of the example computer network of FIG. 1.

FIG. 3 is a flow chart showing an example method in accordance with an embodiment of the present invention.

FIG. 4 is a flow chart showing an example method in accordance with an embodiment of the present invention.

### DETAILED DESCRIPTION

Embodiments of the present invention may include giving framework modules access to the call stack of an operating system in order to ensure proper functionality of the framework module. Embodiments of the present invention may include storing images of call stacks as framework modules are called so that future framework modules can analyze prior call stacks. Embodiments of the present invention may be implemented on a single computer or over a computer network.

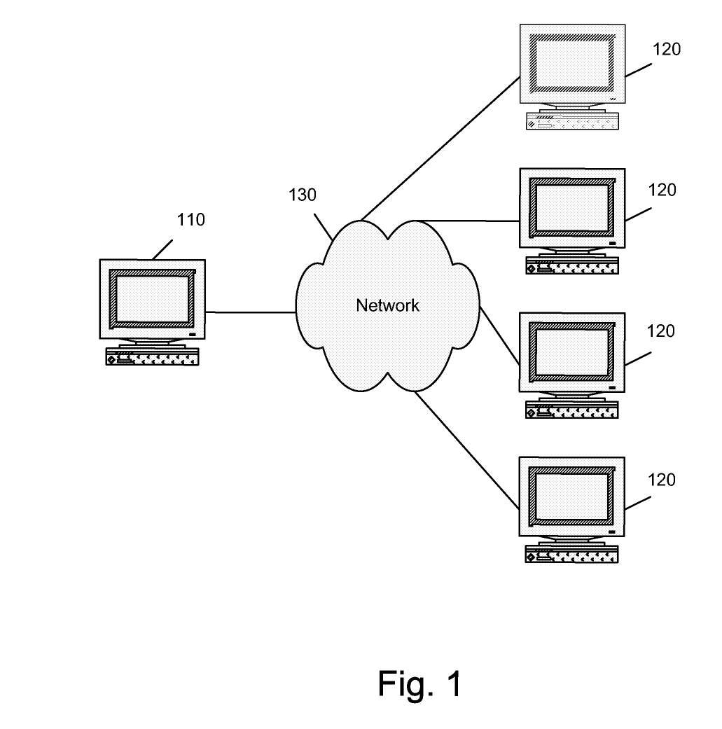

FIG. 1 shows the components of a computer network architecture that may be used implement embodiments of the present invention. The system may contain a user terminal 110 and one or more remote terminals 120 connected through a network 130. The various components and modules described in the present application may be centrally located on the user terminal 110 or may be distributed over the network on the remote terminals 120. Additionally, the various modules and components can be accessible from any of the remote terminals 120 as well as the user terminal 110.

One or more of the terminals 110, 120 may be personal computers, computer workstations, handheld personal digital assistants (“PDA”), or any other type of microprocessor-based device. The network 130 may be a local area network (LAN), wide area network (WAN), remote access network, an intranet, or the Internet, for example. Network links for the network 130 may include telephone lines, DSL, cable networks, T1 or T3 lines, wireless network connections, or any other arrangement that implements the transmission and reception of network signals. However, while FIG. 1 shows the terminals 110, 120 connected through a network 130, the terminals 110, 120 may be connected through other means, including directly hardwired or wirelessly connected. In addition, the terminals 110, 120 may be connected to other network devices not shown, such as wired or wireless routers and servers. The terminals 110, 120 may also be connected to one or more peripheral devices, such a local or network printer, mouse, display, storage drives, etc.

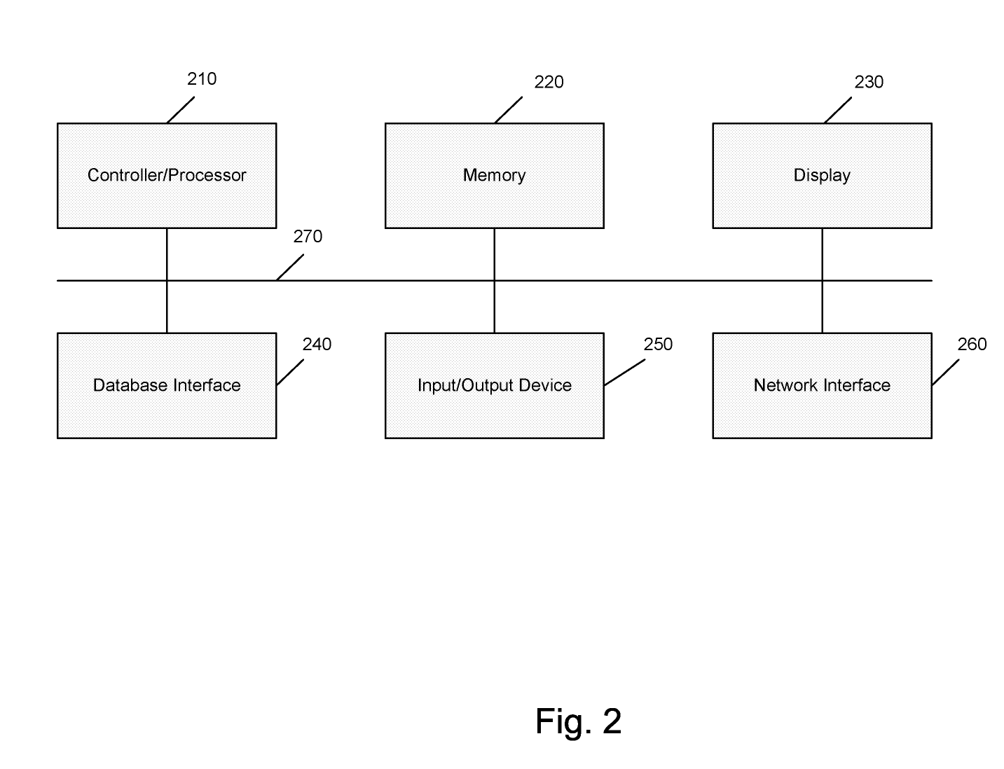

FIG. 2 illustrates a possible configuration of a user or remote terminal 110, 120 A terminal may include a controller/processor 210, memory 220, display 230, database interface 240, input/output device interface 250, and network interface 260, connected through a bus 270.

The controller/processor 210 may be any programmed processor known to one of skill in the art. However, the concepts of the present invention can also be implemented on a general-purpose or a special purpose computer, a programmed microprocessor or microcontroller, peripheral integrated circuit elements, an application-specific integrated circuit (ASIC) or other integrated circuits, hardware/electronic logic circuits, such as a discrete element circuit, a programmable logic device, such as a PLD, PLA, FPGA, or PAL, or the like. In general, any device or devices capable of implementing a framework based software application can be used to implement aspects of the present invention.

The Input/Output interface 250 may be connected to one or more input devices that may include a keyboard, mouse, pen-operated touch screen or monitor, voice-recognition device, or any other device that accepts input. The Input/Output interface 250 may also be connected to one or more output devices, such as a monitor, printer, disk drive, speakers, or any other device provided to output data.

The memory 220 may include volatile and nonvolatile data storage, including one or more electrical, magnetic or optical memories such as a RAM, cache, hard drive, CD-ROM drive, tape drive or removable storage disk.

The network interface 260 may be connected to a communication device, modem, network interface card, or any other device capable of transmitting and receiving signals over a network 130. The components of the terminals 110, 120 may be connected via an electrical bus 270, for example, or linked wirelessly.

Client software and databases may be accessed by the controller/processor 210 from memory 220 or through the database interface 240, and may include, for example, database applications, word processing applications, the client side of a client/server application such as a billing system, as well as components that embody the decision support functionality of the present invention. The terminals 110, 120 may implement any operating system, such as Windows or UNIX, for example. Client and server software may be written in any programming language, such as ABAP, C, C++, Java or Visual Basic, for example.

A system embodying aspects of the present invention is configured to assure proper framework access by creating a call stack by the operating system, providing the call stack to framework modules, and having the framework module evaluate the call stack to assure a correct sequence order of calls.

An operating system can be configured to log all modules that are called during program execution on a call stack stored in RAM. Whenever a module is called, the name of the module can be put on top of the call stack, and whenever the module is exited, it can be “popped,” or removed, from the call stack. In a prior art system, the call stack is usually stored in a local memory area, giving the called modules no access to it.

An embodiment of the present invention includes making the call stack available to the framework modules. A kernel function can be provided so that the framework module might call to retrieve the current call stack from the operating system. The framework module can receive a list of all modules being called on the path to the current module and can store that list in RAM, as a file on a hard drive, or in any other form known in the art. For example, assume, the following modules might be called in the following sequence order: A-B-C-D, meaning module A calls module B, which calls module C which calls Module D. In such an example, module D would retrieve from the operating system the following call stack:

| Level | Module |
|---|---|
| 1 | A |
| 2 | B |
| 3 | C |
| 4 | D |

Module B would only have two hierarchy levels and would retrieve the following call stack:

| Level | Module |
|---|---|
| 1 | A |
| 2 | B |

After receiving the call stack from the operating system, the called module can evaluate the call stack to check which other modules were called prior to the module itself. For example, if framework module X (F-X) evaluates the call stack, it might find a list of modules on the call stack that either belong to the framework as well (i.e. modules, which are known to module X, because they belong to the same framework—in the following donated with prefix “F”) or do not belong to the framework, but instead belong to the application using the framework. Thus a call stack might for example look like as follows:

| Level | Module | Framework/application |
|---|---|---|
| 1 | A | application |
| 2 | B | application |
| 3 | C | application |
| 4 | F-U | framework |
| 5 | D | application |
| 6 | F-V | framework |
| 7 | F-X | framework |

Module F-X might implement certain functionality. This functionality might only work correctly if another framework module (e.g. F-U) has been called in advance. An embodiment of the present invention allows module F-X to check if module F-U has already been called by evaluating the call stack. If module F-U has not been called, then module F-X can react accordingly, for example by showing an error message or raising a proper system exception.

Module F-X might have multiple dependencies and multiple prerequisites necessary for proper functionality. For example, a prior call to a certain framework module might be required but missing, a framework module called before must not be called because it is incompatible with module F-Z, multiple required framework modules were called prior but in a wrong sequence order, or the call stack level of a prior framework module call is wrong (i.e. the module call is required, but on a different call stack level).

If a module such as F-X could not evaluate the call stack and had to continue with its functionality assuming that module F-U had been called, the system behavior would not be well defined. Depending on circumstances, the system might work as excepted; however, it might be that the system runs into a system exception because necessary data is missing. In a particularly undesirable scenario, everything might seem to be working correctly for a period of time but result in a malfunction of the system at a much later point in time. Such a situation may be particularly undesirable when developing software because errors of this nature can be difficult to identify and debug. For example, an error caused by one portion of code might not manifest itself until a much later time when a different portion of code is being developed. An embodiment of the present invention includes allowing a module to access the call stack, and thus verify the prerequisites for proper functionality at the time the module is called rather than having errors manifest themselves later in time.

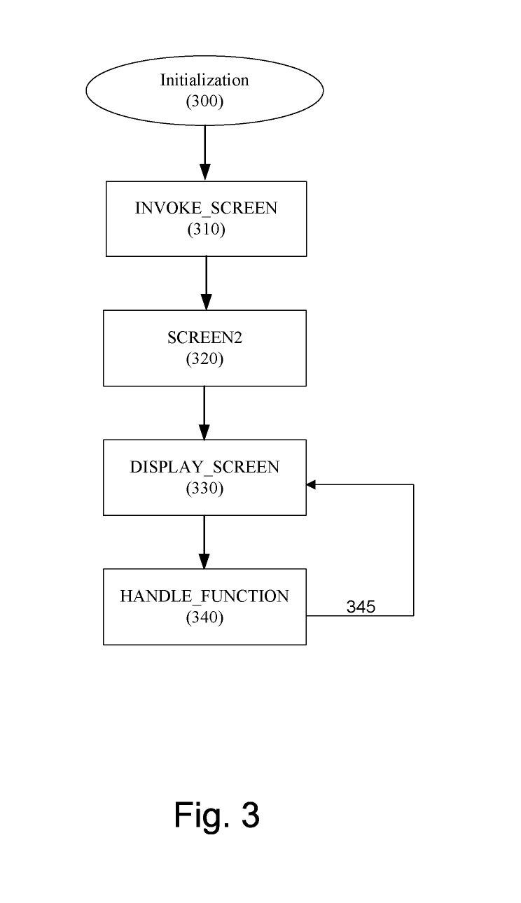

FIG. 3 shows an example of a process embodying aspects of the present invention. The process might start when a program or sub-program is initialized (block 300). An application module (INITIALIZATION) might send a first screen to the computer display. After the user performs some functions on the first screen, the software might call a framework module (INVOKE_SCREEN) to trigger the displaying of a second screen (block 3 10). The INVOKE_SCREEN module might check to see if the second screen replaces the currently displayed first screen, and if it does, it might store all the properties of the currently displayed first screen in order to enable backward navigation. The INVOKE_SCREEN module can then call another application module (SCREEN2) (block 320). The SCREEN2 module can store data, user interface elements, and functions as a parameter. The SCREEN2 module can then call a framework module (DISPLAY_SCREEN) to actually show the screen (block 330). The DISPLAY_SCREEN module can produce a screen based on the parameters passed from the SCREEN2 module. When the user executes a function on the second screen, the DISPLAY_SCREEN module can call an application module (HANDLE_FUNCTION) to execute the function (block 340). The HANDLE_FUNCTION module of the application can evaluate the function executed by the user and perform some actions before ending. The HANDLE_FUNCTION module can provide a return parameter to the DISPLAY_SCREEN module telling the framework, to hide the current screen and replace it with the previous screen. When the DISPLAY_SCREEN module detects that backward navigation should occur, it can retrieve the parameters of the previous screen that were stored during the method INVOKE_SCREEN and deliver those parameter to the DISPLAY_SCREEN module (path 345).

The process described above is summarized in the chart below:

| level | FW/A | Module |
|---|---|---|
| 1 | A | INITIALIZATION |
| 2 | FW | INVOKE_SCREEN |
| 3 | A | SCREEN2 |
| 4 | FW | DISPLAY_SCREEN |
| 5 | A | HANDLE_FUNCTION |
| 4* | FW | DISPLAY_SCREEN |

The first column shows the call stack, i.e. the level of the current module call. Level 4* in the last row means, that level 5 was completed and control was given back to the DISPLAY_SCREEN module which belongs to level 4 again (i.e. after the HANDLE_FUNCTION module was exited, it was popped from the call stack). In level 4* the second screen should be closed and the first screen should be displayed again (with exactly the same data as it had before). Therefore the information about the first screen that was stored when the INVOKE_SCREEN was called has to be retrieved. If the application would not have called the INVOKE_SCREEN module before calling the DISPLAY_SCREEN module, the information would not be stored and backward navigation would not be possible. Therefore, when the application calls the DISPLAY_SCREEN module, it is essential that the INVOKE_SCREEN module has been called before it.

In accordance with embodiments of the present invention, the DISPLAY_SCREEN can access the call stack or an image of the call stack to check for the presence of the INVOKE_SCREEN module. If the INVOKE_SCREEN module is not present, then a suitable error message might be delivered to the user. In the context of developing and debugging new software applications, this error message can be extremely helpful to the software developers because it alerts them immediately to errors or bugs in the code that might otherwise not manifest themselves until later.

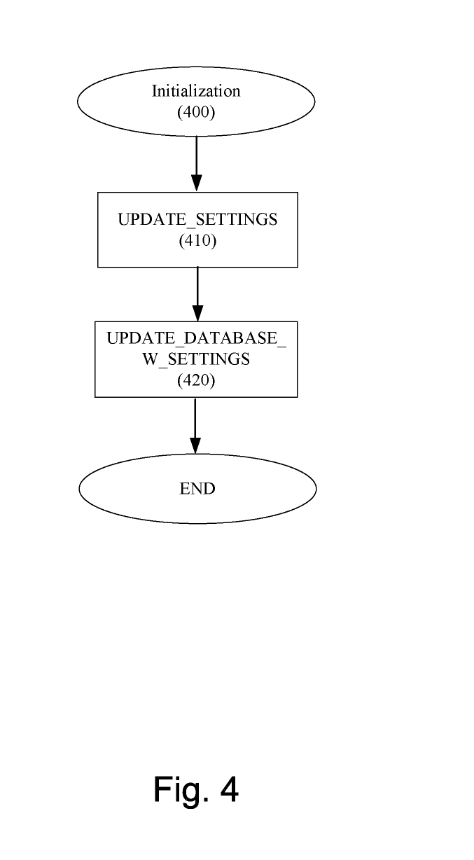

FIG. 4 shows another example of a process embodying aspects of the present invention. The process might start when a program or sub-program is initialized (block 400). An application module (INITIALIZATION) might initialize the application and perform some functions before calling a framework module (UPDATE_SETTINGS) to update some central settings (block 410). The UPDATE_SETTINGS module might verify that the user calling the module is authorized to apply the new settings, and if he is, call another framework module (UPDATE_DATABASE_W_SETTINGS) (block 420). The UPDATE_DATABASE_W_SETTINGS module might store the settings on the database. The process described above is described in the chart below:

| level | FW | Module |
|---|---|---|
| 1 | — | INITIALIZATION |
| 2 | X | UPDATE_SETTINGS |
| 3 | X | UPDATE_DATABASE_W_SETTINGS |

The UPDATE_DATABASE_W_SETTINGS module can store the settings provided by the caller on the database making the settings globally available. However, for some kind of settings, the user might need a certain authorization to apply them. This authorization is checked in method UPDATE_SETTINGS. Thus, for certain kinds of settings, the application is not allowed to call the UPDATE_DATABASE_W_SETTINGS module directly, but has to call the UPDATE_SETTINGS module first. The UPDATE_DATABASE_W_SETTINGS module can verify this by evaluating the call stack. If the UPDATE_SETTINGS module is on the call stack just before the UPDATE_DATABASE_W_SETTINGS module, then the necessary prerequisites have been fulfilled for the UPDATE_DATABASE_W_SETTINGS module to execute.

An embodiment of the present invention includes giving a module access to not only the current call stack but also to call stacks from earlier calls of other framework modules. For example, a framework module F-V might access the following call stack and verify that framework module F-U has been previously called.

| Level | Module | Framework/application |
|---|---|---|
| 1 | A | application |
| 2 | B | application |
| 3 | C | application |
| 4 | F-U | framework |
| 5 | D | application |
| 6 | F-V | framework |

If, however, the methods are finished and popped from the call stack, then the call stack may then look as follows:

| Level | Module | Framework/application |
|---|---|---|
| 1 | A | application |
| 2 | B | application |
| 3 | C | application |

Later on, the application may call another framework module (F-W) and access the following call stack:

| Level | Module | Framework/application |
|---|---|---|
| 1 | A | application |
| 2 | B | application |
| 3 | C | application |
| 4 | F-W | framework |

With this call stack, the framework module cannot verify anything because it only sees application methods on the call stack, and the framework does not know anything about application modules. However, it might be that framework module F-W only works correctly, if framework modules F-U and F-V have been previously called. As they are already finished, framework modules F-U and F-V are no longer on the call stack, but if the call stack was stored when the F-V module was last called, it may be made available to module F-W.

Storing a call stack can be done during each call of a framework method making all information of previously called modules available for later call stack evaluations when other modules are called. If certain framework modules do not have any dependency on other framework modules, then storing the call stack may not be necessary for those modules.

The foregoing description of embodiments is provided to enable a person skilled in the art to make and use the present invention. Various modifications to these embodiments will be readily apparent to those skilled in the art, and the generic principles and specific examples defined herein may be applied to other embodiments without the use of inventive faculty. For example, some or all of the features of the different embodiments discussed above may be deleted from the embodiment or may be combined with features of alternate embodiments. Therefore, the present invention is not intended to be limited to the embodiments described herein but is to be accorded the widest scope defined only by the claims below and equivalents thereof.

What is claimed is:

1. A method of verifying a call stack, the method comprising:
calling a first framework module, the first framework module being dependent on a second framework module;
accessing an image of a call stack;
determining if the second framework module is present in the call stack; and
performing a default operation if the second framework module is not present in the call stack.

2. The method of claim 1, wherein the default operation is outputting an error message.

3. The method of claim 1, further comprising executing the first framework module if the second framework module is present on the call stack.

4. The method of claim 1, further comprising:
accessing stored images of old call stacks; and
determining if the second framework module is present in the old call stacks.

5. The method of claim 1, further comprising storing an image of the call stack in response to the first framework module being called.

6. The method of claim 1, wherein the second framework module is to store security parameters needed by the first framework module.

7. The method of claim 1, further comprising performing a separate default operation if the second framework module is present in the call stack but not compatible with the first framework module.

8. The method of claim 1, further comprising:
determining if a third framework module is present in the call stack; and
performing a default operation if the second framework module and the third framework module are present in the call stack but were executed in an order incompatible with the first framework module.

9. The method of claim 1, wherein the second framework module is to store security parameters needed by the first framework module.

10. A computer program product tangibly embodied in a machine-readable storage device, the product comprising instructions operable to cause data processing apparatus to perform a method, the method comprising:
calling a first framework module, the first framework module being dependent on a second framework module;
accessing an image of a call stack;
determining if the second framework module is present in the call stack; and
performing a default operation if the second framework module is not present in the call stack.

11. The computer program of claim 10, wherein the default operation is outputting an error message.

12. The computer program of claim 10, further comprising:
executing the first framework module if the second framework module is present on the call stack.

13. The computer program of claim 10, further comprising:
accessing stored images of old call stacks; and
determining if the second framework module is present in the old call stacks.

14. The computer program of claim 10, further comprising:
storing an image of the call stack in response to the first framework module being called.

15. The computer program of claim 10, wherein the second framework module is to store security parameters required by the first framework module.

16. A computer program product tangibly embodied in a machine-readable storage device, the product comprising instructions operable to cause data processing apparatus to perform a method, the method comprising:
calling a first framework module, the first framework module being dependent on a second framework module and a third framework module;
accessing an image of a call stack;
determining if the second framework module is present in the call stack;
determining if the third framework module is present in the call stack;
determining if the second framework module and the third framework module were executed in an order compatible with the first framework module;
performing a default operation if the second framework module and the third framework module were not executed in an order compatible with the first framework module.

17. The computer program of claim 16, wherein the default operation is outputting an error message.

18. The computer program of claim 16, further comprising:
accessing stored images of old call stacks;
determining if the second framework module is present in the old call stacks; and
determining if the third framework module is present in the old call stacks.

19. The computer program of claim 16, further comprising:
storing an image of the call stack in response to the first framework module being called.

20. A computer program product tangibly embodied in a machine-readable storage device, the product comprising instructions operable to cause data processing apparatus to perform a method, the method comprising:
calling a first framework module, the first framework module being incompatible with a second framework module;
accessing an image of a call stack;
determining if the second framework module is present in the call stack; and
performing a default operation if the second framework module is present in the call stack.

21. The computer program of claim 20, wherein the default operation is outputting an error message.

22. The computer program of claim 20, further comprising:
accessing stored images of old call stacks; and
determining if the second framework module is present in the old call stacks.

23. The computer program of claim 20, further comprising storing an image of the call stack in response to the first framework module being called.

24. A system for verifying a call stack, comprising:
a first software framework module;
a second software framework module; and
a software call stack,
wherein the first framework module is dependent on the second framework module, an image of the call stack is accessed so as to determine whether the second framework module is present in the call stack and a predetermined default operation is executed if the second framework module is not present in the call stack.

25. The system of claim 24, further comprising:
storing an image of the call stack in response to the first framework module being called.

26. The system of claim 25, further comprising executing the first framework module if the second framework module is present on the call stack.

27. The system of claim 25, wherein the second framework module stores security parameters required by the first framework module.
